(19) United States
(12) Patent Application Publication
(10) Pub. No.: US 2023/0072169 A1
(43) Pub. Date: Mar. 9, 2023

(54) SYSTEMS AND METHODS FOR STEAM CRACKING HYDROCARBONS

(71) Applicant: SABIC GLOBAL TECHNOLOGIES B.V., BERGEN OP ZOOM (NL)

(72) Inventor: Ananth SHARMA, Bangalore (IN)

(73) Assignee: SABIC GLOBAL TECHNOLOGIES B.V., BERGEN OP ZOOM (NL)

(21) Appl. No.: 17/760,146

(22) PCT Filed: Feb. 2, 2021
(86) PCT No.: PCT/IB2021/050840

§ 371 Date: Aug. 4, 2022

Related U.S. Application Data
(60) Provisional application No. 62/971,166, filed on Feb. 6, 2020.

(51) Int. Cl. C10G 9/20; C10G 9/36

(52) U.S. Cl. CPC C10G 9/203; C10G 9/36; C10G 2400/20; C10G 2300/1037

(57) ABSTRACT

A system and a method for steam cracking hydrocarbons are disclosed. The system includes a steam cracking furnace that includes ceramic radiant coils. The system is configured to heat the radiant coils by oxy-fuel combustion in the firebox. The system further includes an oxygen production unit configured to produce pure oxygen used for the oxy-fuel combustion. The effluent from the steam cracking furnace can be further separated into various product streams or fed into a polymerization unit.

### CROSS REFERENCE TO RELATED APPLICATIONS

This application claims the benefit of priority to U.S. Provisional Patent Application Ser. No. 62/971,166, filed Feb. 6, 2020, the entire contents of which are hereby incorporated by reference in their entirety.

### FIELD OF INVENTION

The present invention generally relates to systems and methods for steam cracking hydrocarbons to produce high valued chemicals. More specifically, the present invention relates to a steam cracking system that includes radiant coils made of a ceramic based material and a firebox configured to provide heat to the radiant coils via oxy-fuel combustion.

### BACKGROUND OF THE INVENTION

Steam cracking is one of the most common processes for producing high valued chemicals including light olefins (C₂ to C₄ olefins) and BTX (benzene, toluene, and xylene). In the steam cracking process, hydrocarbons that are mixed with steam are cracked in a steam cracker furnace via pyrolysis. Since its initial design in early 1960s, steam cracker furnaces have evolved significantly over the last few decades, resulting in systems operating under intense heat, shortened residence time, and improved selectivity towards ethylene and propylene.

However, there are still several drawbacks associated with the conventional steam crackers that prevent steam cracking from attaining optimal efficiency. Firstly, the conventional steam cracker uses metallic tubes as the radiant coils, which contain hydrocarbons and steam mixtures and get heated to crack hydrocarbons therein. Metal alloys commonly used for the radiant coil have reasonable high temperature strength up to 1100 to 1150° C. However, the metal alloys have the disadvantage that the interior surface of the tubes and fittings catalyze carbon deposits. As this carbon deposit (also known as coke) grows, it insulates the process gas, resulting in an increase in tube wall temperature (TMT) to provide sufficient heat for the reaction to proceed. The metallic tubes have a maximum operating temperature of about 1150° C., thereby limiting the operating temperature and consequently the residence time of the furnace. Eventually, the TMT limit is reached and the furnace is taken out of service for decoking. Thus, while a given material may be capable of operating at temperatures, for example, of up to 1100° C., the furnace design is limited to a “clean-coil” tube wall temperature of about 1020° C. to allow for the temperature rise. This limitation constrains both how short a residence time may be designed (not below 0.1 second) in a coil and how much feed can be processed in a coil of a given geometry. Furthermore, coke formation in the metallic tubes can lead to high average hydrocarbon partial pressure, which reduces selectivity to light olefins for the steam cracking process. Coke in the radiant coils can also reduce the furnace capacity. The decoking process consumes valuable resources and reduces the life span of the radiant coils. Moreover, the metallic tubes of the conventional steam cracker have a large thermal expansion coefficient. Thus, these radiant coils have to be suspended or supported in the furnace with technically complex solutions. Also, the conventional steam cracker has a large footprint due to the large size of the firebox, limiting the overall capacity of the steam cracker in a fixed space.

Overall, while steam cracking systems and methods of cracking hydrocarbons using the steam crackers exist, the need for improvements in this field persists in light of at least the aforementioned drawbacks for the conventional steam cracking systems.

### BRIEF SUMMARY OF THE INVENTION

A solution to at least some of the above-mentioned problems associated with the steam cracker and steam cracking process has been discovered. The solution resides in a system for steam cracking hydrocarbons and a method of using the system for steam cracking. Notably, the system includes a steam cracking furnace that comprises radiant coils made of a ceramic material. The ceramic material is capable of increasing the operating temperature limit for the furnace, thereby shortening the required residence time of the furnaces. Additionally, the ceramic material does not contain any catalyst for coke formation, resulting in reduced coke formation rate in the radiant coils compared to conventional steam crackers that use radiant coils of nickel and iron-containing metallic alloys. Furthermore, the ceramic material has a lower heat expansion coefficient than metallic alloys, thereby requiring a simpler constructive solution for the cracking furnaces compared to the conventional steam cracker. Moreover, the discovered system can use oxy-fuel combustion in the firebox for heating the radiant coils. Due to the higher heat generated by oxy-fuel combustion compared to air-fuel combustion in conventional steam crackers, the discovered system comprises a significantly smaller firebox than the conventional steam cracker. Therefore, the system and method of the present invention provide a technical solution to at least some of the problems associated with the conventional steam cracker and steam cracking process mentioned above.

Embodiments of the invention include a method of steam cracking hydrocarbons. The method comprises providing a steam cracking furnace comprising radiant coils comprising a ceramic material. The method comprises feeding a mixture comprising steam and hydrocarbons into the steam cracking furnace. The method comprises heating the furnace via oxy-fuel combustion to a reaction temperature sufficient to crack the hydrocarbons in the mixture and produce an effluent stream comprising cracked hydrocarbons. The oxy-fuel combustion comprises combustion between pure oxygen and a fuel. The pure oxygen contains more than 95 wt. % oxygen.

Embodiments of the invention include a method of steam cracking hydrocarbons. The method comprises providing a steam cracking furnace comprising radiant coils made of a ceramic material. The method comprises feeding a mixture comprising steam and hydrocarbons into the steam cracking furnace. The method comprises producing pure oxygen for the oxy-fuel combustion via membrane separation of an oxygen-containing mixture, pressure swing adsorption of an oxygen-containing mixture, cryogenic separation of an oxygen containing mixture, or combinations thereof. The method comprises heating the furnace via oxy-fuel combustion to a reaction temperature sufficient to crack the hydrocarbons in the mixture and produce an effluent stream comprising cracked hydrocarbons. The oxy-fuel combustion comprises combustion between pure oxygen and a fuel.

Embodiments of the invention include an integrated system for steam cracking hydrocarbons. The system comprises an oxygen production unit comprising a membrane separation unit, a pressure swing adsorption separation unit, and/or a cryogenic separation unit, configured to produce pure oxygen that comprises more than 95 wt. % oxygen. The system comprises a steam cracking furnace comprising (a) radiant coils made of a ceramic material and (b) a fire box encompassing the radiant coils and configured to perform oxy-fuel combustion. The system comprises a product separation unit comprising a membrane based separation unit, and/or an adsorption based separation unit.

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “wt. %”, “vol. %” or “mol. %” refer to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, include any measurable decrease or complete inhibition to achieve a desired result.

The term “effective,” as that term is used in the specification and/or claims, means adequate to accomplish a desired, expected, or intended result.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present invention can “comprise,” “consist essentially of,” or “consist of” particular ingredients, components, compositions, etc., disclosed throughout the specification.

The term “primarily,” as that term is used in the specification and/or claims, means greater than any of 50 wt. %, 50 mol. %, and 50 vol. %. For example, “primarily” may include 50.1 wt. % to 100 wt. % and all values and ranges there between, 50.1 mol. % to 100 mol. % and all values and ranges there between, or 50.1 vol. % to 100 vol. % and all values and ranges there between.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 shows a schematic diagram of a system for steam cracking hydrocarbons, according to embodiments of the invention; and

FIG. 2 shows a schematic flowchart of a method of steam cracking a hydrocarbon feed, according to embodiments of the invention.

### DETAILED DESCRIPTION OF THE INVENTION

Currently, steam crackers include radiant coils made of metallic alloys that contain nickel and/or iron. These metallic alloys generally have maximum operating temperatures of about 1150° C., which is not ideal for optimal selectivity to light olefins and short residence time for maximum steam cracking efficiency. Additionally, the nickel and iron in the metallic alloys are catalysts for coke formation during the steam cracking process, resulting in shortened on-stream time for the radiant coils, high average hydrocarbon partial pressure, reduced selectivity to light olefins for the steam cracking process, and reduced furnace capacity. The current steam cracking system also uses air-fuel combustion in the firebox to heat the radiant coil, resulting in lower heating efficiency and requirement for large fireboxes. The present invention provides a solution to at least some of these problems. The solution is premised on a steam cracking system and a method of using the steam cracking system that comprises radiant coils made of a ceramic material. This can be beneficial for at least increasing the upper limit of the operating temperature for the steam cracking furnace, thereby improving the selectivity of light olefins for the steam cracking process. Furthermore, the higher operating temperature of a steam cracker can shorten the required the residence time for the steam cracking furnace, resulting in lower coke formation in the radiant coil and higher production efficiency for the steam cracker. Moreover, the ceramic material does not include any catalyst for coke formation, resulting in lower coke formation in the radiant coils. The disclosed steam cracking system can use oxy-fuel combustion other than air-fuel combustion for conventional steam crackers, resulting in higher heating efficiency of the firebox and lower volumetric requirement for the fireboxes. These and other non-limiting aspects of the present invention are discussed in further detail in the following sections.

### A. System for Steam Cracking Hydrocarbons

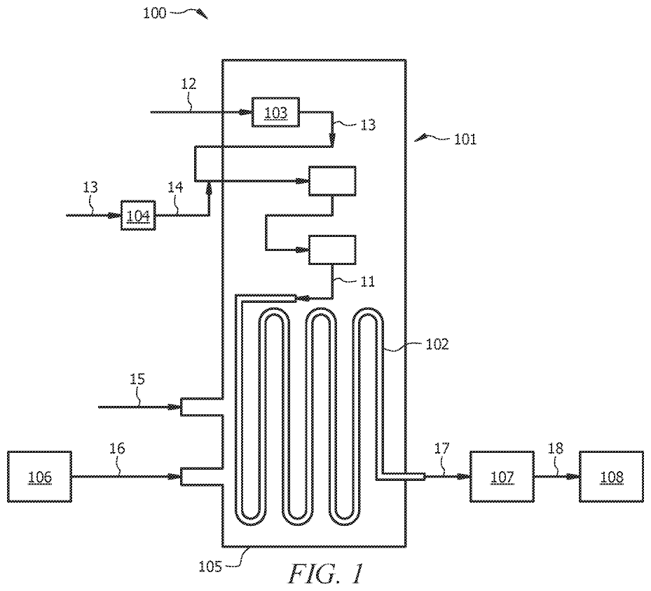

In embodiments of the invention, the system for steam cracking hydrocarbons is capable of facilitating an increase of the upper limit of operating temperature of the furnaces, shortening residence time for the furnaces, and decreasing the coke formation in the radiant coils for the steam cracking process compared to conventional steam cracking systems. With reference to FIG. 1, a schematic diagram is shown for system 100, which is used for steam cracking hydrocarbons with improved efficiency compared to conventional systems.

According to embodiments of the invention, system 100 comprises steam cracking furnace 101 configured to conduct steam cracking of hydrocarbons. In embodiments of the invention, steam cracking furnace 101 includes one or more radiant coils 102 configured to receive feed stream 11 therein and crack hydrocarbons therein. According to embodiments of the invention, feed stream 11 comprises hydrocarbons and steam. System 100, in embodiments of the invention, may include hydrocarbon vaporizer 103 configured to vaporize stream 12 comprising hydrocarbons to form vaporized hydrocarbon stream 13. System 100 may further include steam super heater 104 configured to super heat steam stream 13 to form superheated steam stream 14. Vaporized hydrocarbon stream 13 and superheated steam stream 14 can be mixed together to form feed stream 11. In embodiments of the invention, steam cracking furnace 101 further comprises a feed inlet configured to receive feed stream 11 into radiant coils 102.

Radiant coils 102 may comprise a ceramic material. Non-limiting examples of the ceramic material may include silicon carbide, quartz, silicon nitride, silicon aluminum oxynitride, zirconium oxide, or combinations thereof. Each radiant coil 102 may be tubular. Radiant coil 102, in embodiments of the invention, comprises a metal layer within an annular ceramic wall. The metal within the ceramic wall may not be in contact with any hydrocarbons during a steam cracking process.

In embodiments of the invention, the ceramic material contains substantially no metal that catalyzes coke formation on an inner surface of radiant coils 102. The ceramic material may contain substantially no nickel or iron. Radiant coils 102, in embodiments of the invention, may have an upper limit of operating temperature in a range of 1350 to 1800° C., depending on type of ceramic material used herein. In embodiments of the invention, the ceramic material comprises silicon carbide and the upper limit of operating temperature is in a range of 1350 to 1500° C. and all ranges and values there between including ranges 1350 to 1360° C., 1360 to 1370° C., 1370 to 1380° C., 1380 to 1390° C., 1390 to 1400° C., 1400 to 1410° C., 1410 to 1420° C., 1420 to 1430° C., 1430 to 1440° C., 1440 to 1450° C., 1450 to 1460° C., 1460 to 1470° C., 1470 to 1480° C., 1480 to 1490° C., and 1490 to 1500° C. In embodiments of the invention, the ceramic material comprises alumina and silicon nitride and the upper limit of operating temperature is in a range of 1600 to 1800° C. and all ranges and values there between including ranges of 1600 to 1610° C., 1610 to 1620° C., 1620 to 1630° C., 1630 to 1640° C., 1640 to 1650° C., 1650 to 1660° C., 1660 to 1670° C., 1670 to 1680° C., 1680 to 1690° C., 1690 to 1700° C., 1700 to 1710° C., 1710 to 1720° C., 1720 to 1730° C., 1730 to 1740° C., 1740 to 1750° C., 1750 to 1760° C., 1760 to 1770° C., 1770 to 1780° C., 1780 to 1790° C., and 1790 to 1800° C.

In embodiments of the invention, a volumetric ratio of firebox 105 to radiant coils 102 may be in a range of 10 to 20 and all ranges and values there between including ranges of 10 to 11, 11 to 12, 12 to 13, 13 to 14, 14 to 15, 15 to 16, 16 to 17, 17 to 18, 18 to 19, and 19 to 20. Firebox 105 may be configured to host oxy-fuel combustion to provide reaction heat to radiant coils 102. In embodiments of the invention, firebox 105 is made of CS and various refractory materials. In embodiments of the invention, an outer casing of firebox 105 can be made of carbon steel, and an inner lining of the outer casing includes 2 to 5 layers of various refractory materials. Firebox 105 may have an upper limit of operating temperature in a range of 1400 to 2000° C. and all ranges and values there between including ranges of 1400 to 1450° C., 1450 to 1500° C., 1500 to 1550° C., 1550 to 1600° C., 1600 to 1650° C., 1650 to 1700° C., 1700 to 1750° C., 1750 to 1800° C., 1800 to 1850° C., 1850 to 1900° C., 1900 to 1950° C., and 1950 to 2000° C.

According to embodiments of the invention, firebox 105 includes a fuel inlet configured to receive fuel stream 15 therein. Firebox 105 further includes an oxygen inlet configured to receive oxygen stream 16 therein. In embodiments of the invention, the fuel inlet and the oxygen inlet may be the same. In embodiments of the invention, fuel stream 15 includes CH₄, H₂, or combinations thereof. In embodiments of the invention, fuel stream 15 includes 50 to 80 mol. % H₂ and 20 to 50 mol. % CH₄. Fuel stream 15 may further include ethylene or ethane. Fuel stream 15 may include natural gas that contains at least some nitrogen. Oxygen stream 16 may include more than 95 wt. % oxygen or pure oxygen.

According to embodiments of the invention, system 100 comprises oxygen production unit 106 configured to produce oxygen stream 16. Oxygen production unit 106 may include a membrane separation unit, a pressure swing adsorption unit, a cryogenic separation unit, or any combination thereof. The membrane separation unit, the cryogenic separation unit, and the pressure swing adsorption unit may be configured to separate oxygen from an oxygen-containing mixture including air. The membrane separation unit may comprise membrane modules containing ceramic membrane. The cryogenic separation unit may include one or more cryogenic distillation columns configured to separate air to produce oxygen via a cryogenic process. In embodiments of the invention, an outlet of oxygen production unit 106 is in fluid communication with the oxygen inlet of firebox 105 such that oxygen stream 16 flows from oxygen production unit 106 to firebox 105.

According to embodiments of the invention, system 100 further comprises cooling unit 107 in fluid communication with an outlet of steam cracking furnace 101 such that effluent stream 17 from radiant coils 102 flows to cooling unit 107. In embodiments of the invention, cooling unit 107 is configured to cool effluent stream 17 to a temperature sufficient to terminate reaction of hydrocarbons in effluent stream 17. In embodiments of the invention, cooling unit 107 may include a transfer-line exchanger, an oil quench tower, or combinations thereof.

According to embodiments of the invention, system 100 includes product separation unit 108 in fluid communication with an outlet of cooling unit 107 such that cooled effluent stream 18 flows from cooling unit 107 to product separation unit 108. In embodiments of the invention, product separation unit 108 includes a membrane based separation unit or an adsorption based separation unit, a distillation unit, or combinations thereof. In addition to, or as an alternative to feeding cooled effluent stream 18 to product separation unit 108, at least a portion of cooled effluent stream 18 may be fed into a polymerization unit such that olefins, alkynes, and/or other unsaturated hydrocarbons in cooled effluent stream 18 are polymerized to produce polymer products.

### B. Method of Steam Cracking Hydrocarbons

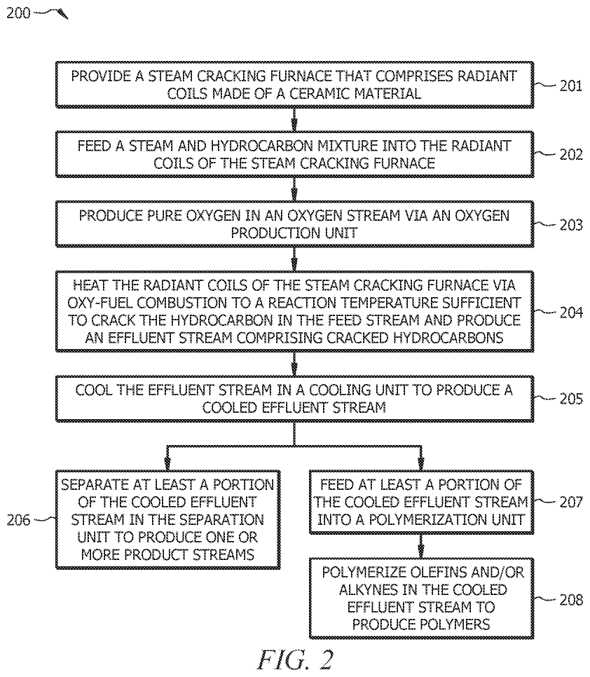

Methods for steam cracking hydrocarbons have been discovered. As shown in FIG. 2, embodiments of the invention include method 200 for steam cracking hydrocarbons. Method 200 may be implemented by system 100, as shown in FIG. 1 and described above.

According to embodiments of the invention, as shown in block 201, method 200 comprises providing steam cracking furnace 101, which comprises radiant coils 102 made of the ceramic material. In embodiments of the invention, method 200 comprises feeding feed stream 11 comprising a steam and hydrocarbon mixture into steam cracking furnace 101, as shown in block 202. The steam and hydrocarbon mixture may have a steam to hydrocarbon ratio of 0.1 to 0.5 and all ranges and values there between including 0.2, 0.3, and 0.4. Feed stream 11 may be at a temperature of 500 to 700° C. and all ranges and values there between. In embodiments of the invention, the hydrocarbons may include lower paraffins (C₂ to C₄ paraffins including (1) ethane and propane, (2) propane and butane), naphtha, liquefied petroleum gas, or combinations thereof. The steam and hydrocarbon mixture at block 202 may be 100 wt. % gaseous.

According to embodiments of the invention, as shown in block 203, method 200 includes producing pure oxygen in oxygen stream 16 via oxygen production unit 106. In embodiments of the invention, pure oxygen means gas that includes at least 95 wt. % oxygen. In embodiments of the invention, producing at block 203 includes separating oxygen from air in a membrane separation unit and/or a pressure swing adsorption unit. The membrane separation unit may include ceramic membranes. The pressure swing adsorption unit may include a pressure swing adsorption tower. In embodiments of the invention, producing at block 203 may further include cryogenically distilling air to produce pure oxygen.

According to embodiments of the invention, as shown in block 204, method 200 includes, via oxy-fuel combustion, heating radiant coils 102 of steam cracking furnace 101 to a reaction temperature sufficient to crack the hydrocarbon in feed stream 11 and produce effluent stream 17 comprising cracked hydrocarbons. In embodiments of the invention, heating at block 204 includes feeding fuel stream 15 and oxygen stream 16 into firebox 105 of steam cracking furnace 101 and performing oxy-fuel combustion with the fuel of fuel stream 15 and oxygen of oxygen stream 16. In embodiments of the invention, the fuel and oxygen are fed into firebox 105 at a volumetric ratio determined as about 5 to 10% excessive oxygen over stoichiometric ratios. Steam cracking furnace 101 can be operated using induced draft, forced draft, and/or balanced draft options. Balanced draft, in embodiments of the invention, can facilitate preheating air, which is used for providing oxygen in oxy-fuel combustion, with flue gas from firebox 105 (stack). In embodiments of the invention, at least some of the flue gas is recycled back to the burners to ensure that the flame in the burners temperature is controlled. Percentage of flue gas recycled back to the burners can be dependent upon desired temperature for firebox 105. In embodiments of the invention, about 20 to 50% flue gas from stack is recycled and mixed with pure oxygen of oxygen stream 16 to control combustion temperature to be below 2000° C. such that maximum skin temperature of cracking furnace 101 can be maintained below a limit of about 1600° C. In embodiments of the invention, at block 204, the oxy-fuel combustion includes combustion between the fuel and the pure oxygen. At block 204, the reaction temperature sufficient to crack the hydrocarbons may be in a range of 850 to 1400° C. and all ranges and values there between including ranges of 850 to 900° C., 900 to 950° C., 950 to 1000° C., 1000 to 1050° C., 1050 to 1100° C., 1100 to 1150° C., 1150 to 1200° C., 1200 to 1250° C., 1250 to 1300° C., 1300 to 1350° C., and 1350 to 1400° C. According to embodiments of the invention, at block 204, steam cracking furnace 101 is operated with a residence time of 0.01 to 0.15 ms and all ranges and values there between including ranges of 0.01 to 0.03 ms, 0.03 to 0.05 ms, 0.05 to 0.07 ms, 0.07 to 0.09 ms, 0.09 to 0.11 ms, 0.11 to 0.13 ms, and 0.13 to 0.15 ms. In embodiments of the invention, at block 204, the hydrocarbons are cracked at a conversion rate of greater than 70%.

According to embodiments of the invention, as shown in block 205, method 200 includes cooling effluent stream 17 in cooling unit 107 to produce cooled effluent stream 18. In embodiments of the invention, method 200 further includes separating at least a portion of cooled effluent stream 18 in product separation unit 108 to produce one or more product streams, as shown in block 206. In embodiments of the invention, product separation unit 108 may include a membrane based separation unit. The product streams may include ethylene and/or propylene.

According to embodiments of the invention, as shown in block 207, method 200 includes feeding at least a portion of cooled effluent stream 18 into a polymerization unit. As shown in block 208, method 200 further includes polymerizing olefins and/or alkynes in cooled effluent stream 18 to produce polymers.

In the context of the present invention, at least the following 17 embodiments are described. Embodiment 1 is a method of steam cracking hydrocarbons. The method includes providing a steam cracking furnace including radiant coils containing a ceramic material. The method further includes feeding a mixture containing steam and hydrocarbons into the steam cracking furnace, and heating the furnace via oxy-fuel combustion to a reaction temperature sufficient to crack the hydrocarbons in the mixture and produce an effluent stream containing cracked hydrocarbons, wherein the oxy-fuel combustion includes combustion between pure oxygen and a fuel. Embodiment 2 is the method of embodiment 1, wherein the pure oxygen contains more than 95 wt. % oxygen. Embodiment 3 is the method of either of embodiments 1 or 2, wherein the oxy-fuel combustion is performed at an oxygen to fuel molar ratio that is about 5-10% excess oxygen over stoichiometric ratio in a combustion reaction of the fuel. Embodiment 4 is the method of any of embodiments 1 to 3, wherein the heating step is performed in a firebox encompassing the radiant coils. Embodiment 5 is the method of any of embodiments 1 to 4, wherein the fuel in the oxy-fuel combustion is selected from the group consisting of CH₄, H₂, natural gas, and combinations thereof. Embodiment 6 is the method of any of embodiments 1 to 5, further including, prior to the heating step, producing pure oxygen for the oxy-fuel combustion via membrane separation of an oxygen-containing mixture, pressure swing adsorption of an oxygen-containing mixture, cryogenic separation of an oxygen-containing mixture, or combinations thereof. Embodiment 7 is the method of embodiment 6, wherein the oxygen containing mixture includes air. Embodiment 8 is the method of any of embodiments 1 to 7, wherein the ceramic material includes ceramics, mixed ceramics, quartz, silicon carbide, silicon nitride, silicon aluminum oxynitride, zirconium oxide, or combinations thereof. Embodiment 9 is the method of any of embodiments 1 to 8, wherein the mixture containing steam and hydrocarbons has a steam to hydrocarbon weight ratio of 0.1 to 0.5. Embodiment 10 is the method of any of embodiments 1 to 9, wherein the hydrocarbons in the mixture contain naphtha and the cracked hydrocarbons in the effluent stream contain ethylene and propylene. Embodiment 11 is the method of any of embodiments 1 to 10, wherein, in the heating step, the furnace is heated to a temperature of 1400 to 2000° C. Embodiment 12 is the method of any of embodiments 1 to 11, wherein a residence time for heating the mixture of steam and hydrocarbons in the radiant coils is in a range of 0.01 to 0.15 ms. Embodiment 13 is the method of any of embodiments 1 to 12, wherein the hydrocarbons are cracked so that a conversion rate of the hydrocarbons is in a range of 70 to 100%. Embodiment 14 is the method of any of embodiments 1 to 13, further including separating the effluent stream via a membrane based separation unit to produce one or more product streams containing ethylene and/or propylene. Embodiment 15 is the method of any of embodiments 1 to 13, further including feeding the effluent stream into a polymerization unit and polymerizing olefins of the effluent stream to produce polymers.

Embodiment 16 is an integrated system for producing olefins. The system includes an oxygen production unit includes a membrane separation unit, a pressure swing adsorption separation unit, and/or a cryogenic separation unit, configured to produce pure oxygen, which contains more than 95 wt. % oxygen. The system further includes a steam cracking furnace including (a) radiant coils made of a ceramic material and (b) a fire box encompassing the radiant coils and configured to perform oxy-fuel combustion. The system still further includes a product separation unit including a membrane based separation unit, and/or an adsorption based separation unit. Embodiment 17 is the integrated system of embodiment 16, wherein the steam cracking furnace is in fluid communication with a polymerization unit such that an effluent from the steam cracking furnace is fed to the polymerization unit.

Although embodiments of the present invention have been described with reference to blocks of FIG. 2, it should be appreciated that operation of the present invention is not limited to the particular blocks and/or the particular order of the blocks illustrated in FIG. 2. Accordingly, embodiments of the invention may provide functionality as described herein using various blocks in a sequence different than that of FIG. 2.

The systems and processes described herein can also include various equipment that is not shown and is known to one of skill in the art of chemical processing. For example, some controllers, piping, computers, valves, pumps, heaters, thermocouples, pressure indicators, mixers, heat exchangers, and the like may not be shown.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method of steam cracking hydrocarbons, the method comprising:
providing a steam cracking furnace including radiant coils comprising a ceramic material;
feeding a mixture comprising steam and hydrocarbons into the steam cracking furnace; and
heating the furnace via oxy-fuel combustion to a reaction temperature sufficient to crack the hydrocarbons in the mixture and produce an effluent stream comprising cracked hydrocarbons;
wherein the oxy-fuel combustion comprises combustion between pure oxygen and a fuel.

2. The method of claim 1, wherein the pure oxygen comprises more than 95 wt. % oxygen.

3. The method of claim 1, wherein the oxy-fuel combustion is performed at an oxygen to fuel molar ratio that is about 5-10% excess oxygen over stoichiometric ratio in a combustion reaction of the fuel.

4. The method of claim 1, wherein the heating step is performed in a firebox encompassing the radiant coils.

5. The method of claim 1, wherein the fuel in the oxy-fuel combustion is selected from the group consisting of CH₄, H₂, natural gas, and combinations thereof.

6. The method of claim 1, further comprising:
prior to the heating step, producing pure oxygen for the oxy-fuel combustion via membrane separation of an oxygen-containing mixture, pressure swing adsorption of an oxygen-containing mixture, cryogenic separation of an oxygen-containing mixture, or combinations thereof.

7. The method of claim 6, wherein the oxygen containing mixture comprises air.

8. The method of claim 1, wherein the ceramic material comprises ceramics, mixed ceramics, quartz, silicon carbide, silicon nitride, silicon aluminum oxynitride, zirconium oxide, or combinations thereof.

9. The method of claim 1, wherein the mixture comprising steam and hydrocarbons has a steam to hydrocarbon weight ratio of 0.1 to 0.5.

10. The method of claim 1, wherein the hydrocarbons in the mixture comprise naphtha and the cracked hydrocarbons in the effluent stream comprise ethylene and propylene.

11. The method of claim 1, wherein, in the heating step, the furnace is heated to a temperature of 1400 to 2000° C.

12. The method of claim 1, wherein a residence time for heating the mixture of steam and hydrocarbons in the radiant coils is in a range of 0.01 to 0.15 ms.

13. The method of claim 1, wherein the hydrocarbons are cracked so that a conversion rate of the hydrocarbons is in a range of 70 to 100%.

14. The method of claim 1, further comprising:
separating the effluent stream via a membrane based separation unit to produce one or more product streams comprising ethylene and/or propylene.

15. The method of claim 1, further comprising:
feeding the effluent stream into a polymerization unit; and
polymerizing olefins of the effluent stream to produce polymers.

16. The method of claim 3, further comprising:
feeding the effluent stream into a polymerization unit; and
polymerizing olefins of the effluent stream to produce polymers.

17. The method of claim 4, further comprising:
feeding the effluent stream into a polymerization unit; and
polymerizing olefins of the effluent stream to produce polymers.

18. The method of claim 5, further comprising:
feeding the effluent stream into a polymerization unit; and
polymerizing olefins of the effluent stream to produce polymers.

19. An integrated system for producing olefins, the system comprising:
an oxygen production unit comprising a membrane separation unit, a pressure swing adsorption separation unit, and/or a cryogenic separation unit, configured to produce pure oxygen, which comprises more than 95 wt. % oxygen;
a steam cracking furnace comprising (a) radiant coils made of a ceramic material and (b) a fire box encompassing the radiant coils and configured to perform oxy-fuel combustion;
a product separation unit comprising a membrane based separation unit, and/or an adsorption based separation unit.

20. The integrated system of claim 19, wherein the steam cracking furnace is in fluid communication with a polymerization unit such that an effluent from the steam cracking furnace is fed to the polymerization unit.
